(19) United States
(12) Patent Application Publication
(10) Pub. No.: US 2011/0167190 A1
(43) Pub. Date: Jul. 7, 2011

(54) Apparatus and method for distant bus extended system

(76) Inventors: Hung-Ming LIN, Hsin Chu City (TW); Hung-Ju Huang, Hsinchu City (TW); Jen-Min Yuan, Hsinchu City (TW); Ming-Chi Bai, Hsinchu City (TW)

(21) Appl. No.: 13/040,831

(22) Filed: Mar. 4, 2011

Related U.S. Application Data
(63) Continuation-in-part of application No. 12/203,007, filed on Sep. 2, 2008, now abandoned.

(51) Int. Cl. G06F 13/20

(52) U.S. Cl. 710/313

(57) ABSTRACT

The invention discloses a distant PCIe extended system. The distant PCIe extended system includes a local PCIe virtualization device (PVD), at least a transmission medium and at least a remote PVD. The PVD includes a PCIe PHY layer, a signal converting circuit, at least a PVD PHY layer and a transmission medium. The PCIe PHY layer is used to receive a PCIe physical signal. The signal converting circuit is coupled to the PCIe PHY layer and used to convert the PCIe data link layer packet into at least a PVD MAC packet. The PVD PHY layer is coupled to the signal converting circuit and used to process and transfer the PVD MAC packet. The transmission medium receives and transfers the PVD physical signal.

### CROSS-REFERENCE TO RELATED APPLICATIONS

This application is a Continuation-in-Part of co-pending application Ser. No. 12/203,007, filed on Sep. 2, 2008, and for which priority is claimed under 35 U.S.C. §120, the entire contents of which are hereby incorporated by reference.

### BACKGROUND OF THE INVENTION

(a) Field of the Invention

The present invention relates to a bus extended computer system architecture, and particularly to a long-distant computer peripheral component interconnect express (PCIe) extended bus system.

(b) Description of the Related Art

Currently, the distance for bus of a general computer peripheral component interconnect express (PCI Express, hereinafter abbreviated as: PCIe) interface is limited and, therefore, such bus can only be used for a short distance. To resolve the distance limitation problem of signal transmission by PCIe, a PCI Express External Cabling specification has been proposed in other technical fields to increase the signal transmission distance. However, using the transmission line consistent with the PCI Express External Cabling specification to transmit data causes the problem of increasing cost dramatically and the distance still limited to 20-30 m.

### BRIEF SUMMARY OF THE INVENTION

Therefore, in order to resolve the above mentioned problems, one object of the invention is to provide a distant PCIe extended system that can virtualize and transfer the PCIe physical signals through at least a general transmission medium line (such as: a twisted pair cable or an optical fiber line). On the other side of transmission medium, a remote terminal receives the virtualized signals and recovers the PCIe physical signal again.

One object of the invention is to provide a distant PCIe extended system that can reduce the production cost.

One object of the invention is to provide a distant PCIe extended system that can reduce the purchasing cost for consumers.

One object of the invention is to provide a distant PCIe extended system that can increase the transmission distance dramatically (over 100 m).

According to one embodiment of the invention in FIG. 6A, a distant PCIe extended computer system 60 is provided by adding a local PCIe virtualization device (PCIe virtualization device, hereinafter abbreviated as: PVD) 100a, a remote PVD 100b and a transmission medium 104 into a conventional PCIe computer system 50 as shown in FIG. 5. The at least a PCIe physical signal (PDS) is virtualized and transformed to at least a PVD physical signal (PVS) by a local PVD 100a. The at least a PVS is transmitted through a transmission medium 104 to the remote PVD 100b. The remote PVD receives and transforms the at least a PVS into at least a PDS. According to the present invention, the PCIe header, PCIe data, and PCIe ECRE of the reconstructed PDS is equivalent to the original PDS. The at least a PDS in remote terminal 60b can follow the same procedure to be sent to a host computer 60a. According to the present invention, the PCIe header, PCIe data, and PCIe ECRE of the reconstructed PDS is equivalent to the original PDS. These make the distant PCIe extended computer system 60 is virtually equivalent to the original PCIe computer system 50.

According to another embodiment of the invention in FIG. 9C, a distant PCIe extended computer system 90″ is provided by adding more than one remote PVD 100b and more than one transmission medium 104 into distant PCIe extended computer system 60 as shown in FIG. 6A. The at least a PCIe physical signal (PDS) is virtualized and transformed to at least a PVD physical signal (PVS) by local PVD 100a. The local PVD 100a decodes the PCIe transaction layer packet, which is generated during transforming and deciding one of the remote terminals 60b, and sends the PVS to the selected remote terminal 60b. The at least a PVS is transmitted through the selected transmission medium 104 to the remote PVD 100b in the selected remote terminal 60b. The remote PVD 100b receives and transforms the at least a PVS into at least a PDS. According to the present invention, the PCIe header, PCIe data, and PCIe ECRE of the reconstructed PVD is equivalent to the original PDS. The at least a PDS in one of the remote terminal 60b can follow the same procedure to send to the host computer 90a″. Therefore, the above mentioned mechanism makes the distant PCIe extended computer system 90″ can have multiple remote terminal 60b.

According to another embodiment of the invention, a bus signal extended transmission method is provided. The method includes the following steps. At first, at least a sideband signal is received. It is determined if the sideband signal is consistent with the preset specification or size. The sideband signal is converted into at least a data packet. The data packet is transmitted through a twisted pair cable or an optical fiber line. Then, the data packet is received through the twisted pair cable or the optical fiber line. It is determined if the data of the data packet is correct according to the preset coding. Thereafter, the data packet is converted into at least a sideband signal.

According to another embodiment of the invention, a distant PCIe extended computer system is provided. The distant PCIe extended computer system comprises a host processor, a root complex and a distant PCIe bus fabric. The root complex, coupled between the host processor and a distant PCIe bus fabric, is used for initiating transaction requests on the behalf of the host processor, The distant PCIe bus fabric comprises a transmission medium for transmission of a PVD physical signal; at least a local PVD (PCIe Virtualization Device), coupled to the transmission medium, for converting signals between a PCIe physical signal and a PVD physical signal; and at least a remote PVD, coupled to the transmission medium, for converting signals between the PCIe physical signal and the PVD physical signal. Further, the host processor communicates with at least a PCIe device through the root complex and the distant PCIe bus fabric.

The distant bus extended method according to the embodiments of the invention utilize the signal converting circuit to convert the PCIe interface signal into a data packet and then transfer the data packet through the transmission medium via the PVD PHY layer. Therefore, the distant bus extended method according to the embodiments of the invention can accommodate long-distance, over 100 meters, data transmission through a twisted pair cable or an optical fiber line. Besides, the PVD PHY layer can be implemented by existing commonly available devices that are provided with the physical layer circuit. Thus, the existing commonly available a twisted pair cable or an optical fiber line can be utilized as the transmission medium for such data transmission. In conclusion, by way of the above mentioned approaches, the distant PCIe extended system and the method according to the embodiments of the invention can greatly reduce the design expense and the production cost while better transmission efficiency compared to the prior technique can be achieved.

### BRIEF DESCRIPTION OF THE DRAWINGS

FIG. 1A shows a schematic diagram illustrating the distant PCIe extended system according to one embodiment of the invention;

FIG. 1B shows a schematic diagram illustrating the local PVD and remote PVD according to another embodiment of the invention;

FIG. 1C shows a schematic diagram illustrating the local PVD and remote PVD according to another embodiment of the invention;

FIG. 2A shows a schematic diagram illustrating the distant PCIe extended system according to another embodiment of the invention;

FIG. 2B shows a schematic diagram illustrating the distant PCIe extended system according to another embodiment of the invention;

FIG. 2C shows a schematic diagram illustrating the local PVD according to another embodiment of the invention;

FIG. 3A shows a schematic diagram illustrating the distant PCIe extended system according to another embodiment of the invention;

FIG. 3B shows a schematic diagram illustrating the local PVD according to another embodiment of the invention;

FIGS. 4A and 4B show flow charts illustrating the distant bus extended method according to one embodiment of the invention.

FIG. 5 shows schematic diagrams illustrating a conventional PCIe computer system according to prior art.

FIG. 6A shows a schematic diagram illustrating a distant PCIe extended computer system 60 according to one embodiment the invention.

FIG. 6B shows data flow diagram of a local PVD according to one embodiment the invention.

FIG. 6C shows data flow diagram of a remote PVD according to one embodiment the invention.

FIG. 6D shows an exemplary example of data flow of the local PVD according to one embodiment the invention.

FIG. 6E shows an exemplary example of data flow of the remote PVD according to one embodiment the invention.

FIG. 6F shows another exemplary example of data flow of the local PVD according to one embodiment the invention.

FIG. 6G shows another exemplary example of data flow of the remote PVD according to one embodiment the invention.

FIG. 7A shows a schematic diagram illustrating a conventional LAN subsystem.

FIG. 7B shows one example of a part data flow diagram of the prior LAN subsystem shown in FIG. 7A.

FIG. 7C shows one example of another part data flow diagram, of the prior LAN subsystem shown in FIG. 7A.

FIG. 8A shows an embodiment of the invention of a part flow diagram of side band signals OF, Re, Led and GP shown in FIG. 3A.

FIG. 8B shows an embodiment of the invention of another part flow diagram of the side band signals OF, Re, Led and GP shown in FIG. 3A.

FIG. 8C shows an embodiment of the invention of a part flow diagram of PVD Link control data transmitting.

FIG. 8D shows an embodiment of the invention of another part flow diagram of PVD Link control data transmitting.

FIG. 9A shows another embodiment of the distant PCIe extended computer system.

FIG. 9B shows another embodiment of the distant PCIe extended computer system.

FIG. 9C shows another embodiment of the distant PCIe extended computer system.

### DETAILED DESCRIPTION OF THE INVENTION

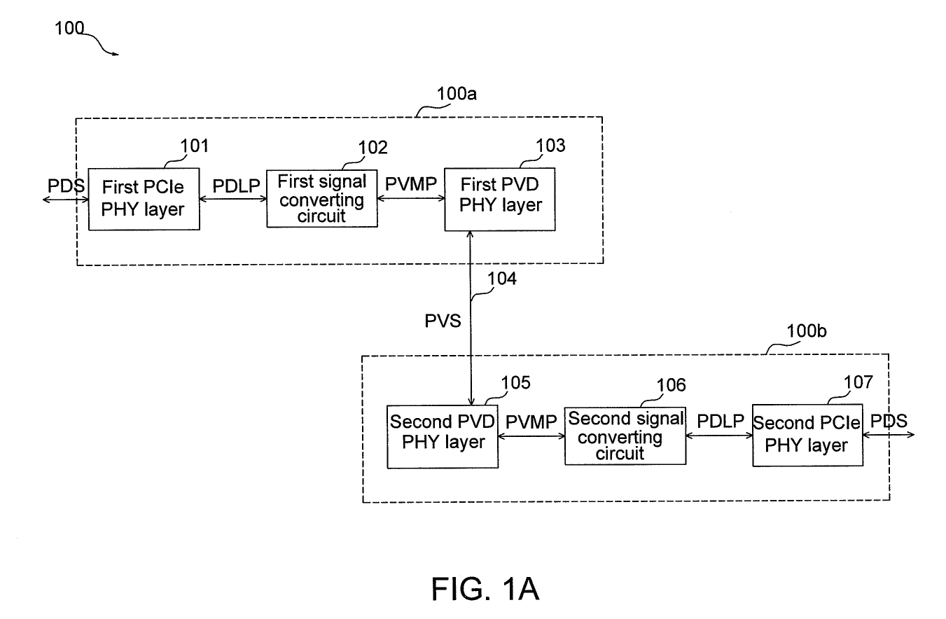

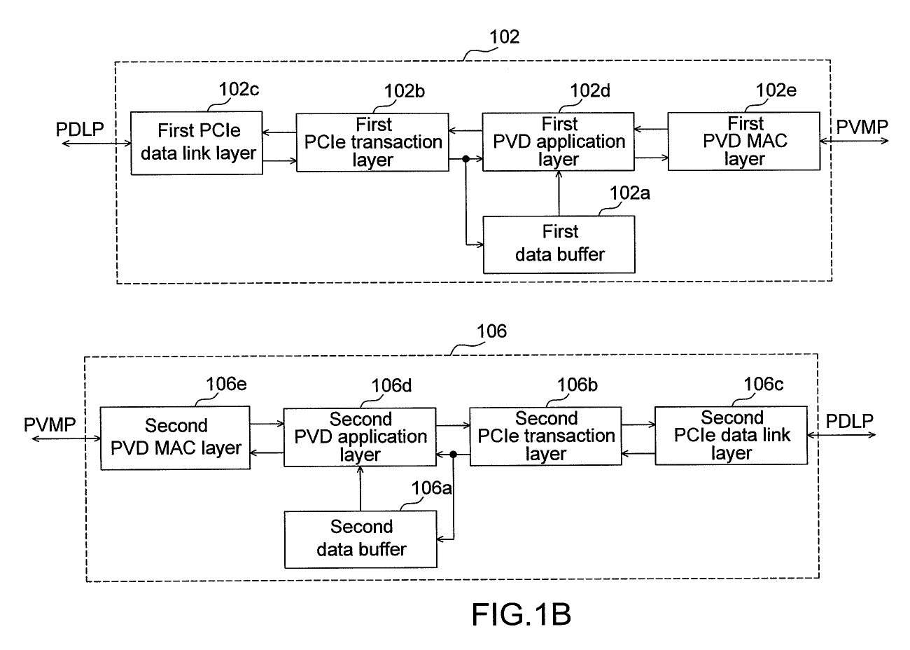

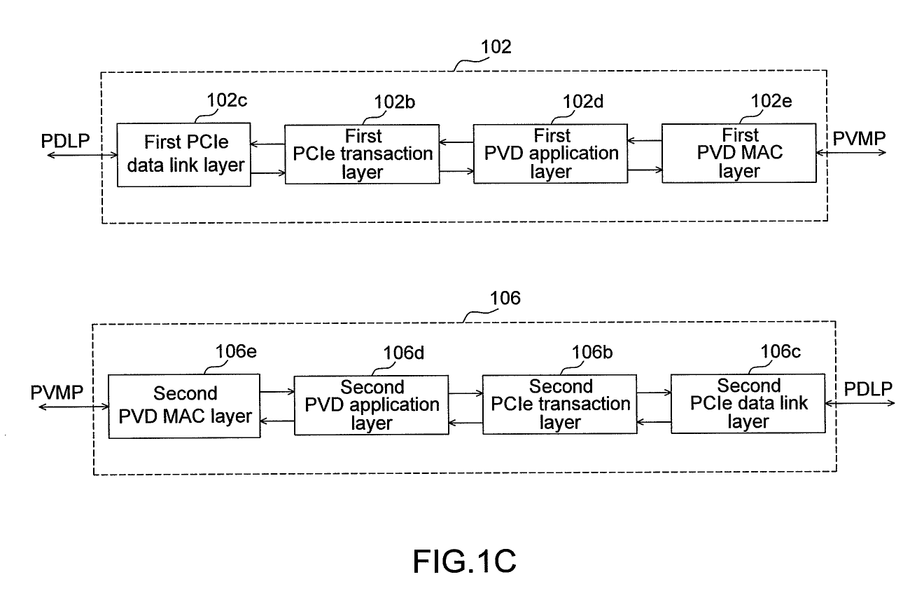

FIG. 1A shows schematic diagrams illustrating the distant PCIe extended system according to one embodiment of the invention. A distant PCIe extended system 100 includes a local PVD 100a, a transmission medium 104, and a remote PVD 100b. The local PVD 100a includes a first PCIe PHY layer 101, a first signal converting circuit 102, and a first PVD PHY layer 103. Correspondingly, the remote PVD 100b also includes a second PVD PHY layer 105, a second signal converting circuit 106, and a second PCIe PHY layer 107.

The first PCIe PHY layer 101 is used for transferring at least a PCIe physical signal PDS.

The signal converting circuit 102 is coupled to the first PCIe PHY layer 101 and used to convert the PCIe physical signal PDS into at least a PVD MAC packet PVMP. The PVD MAC packet PVMP according to one embodiment of the invention may be a network packet or a packet that does not include the internet protocol (IP). The PVD MAC packet PVMP according to another embodiment of the invention can be a data packet having currently available specifications or various specifications to be developed in the future.

Referring to FIG. 1B, the first signal converting circuit 102 according to one embodiment of the invention includes a first data buffer 102a, a first PCIe transaction layer 102b, a first PCIe data link layer 102c, a first PVD application layer 102d and a first PVD MAC layer 102e. It should be noted that the first signal converting circuit 102 according to one embodiment of the invention may be used for converting the PCIe interface into a media independent interface (RMII), a gigabit media independent interface (RGMII), or various other kinds of physical layer interfaces (such as a kind of physical layer interface presets by a designer).

Referring to FIG. 1B, the first PCIe data link layer 102c determines if it is to receive the PCIe data link layer packet PDLP. Then, when the first PCIe data link layer 102c determines to receive the PCIe data link layer packet PDLP, the first PCIe data link layer 102c generates and supplies a PCIe transaction layer packet to the first PCIe transaction layer 102b. According to a request packet, the first PCIe transaction layer 102b processes the data temporarily stored in the first data buffer 102a in order to output a PCIe transaction layer packet from the data buffer 102a to the first PVD application layer 102d. It should be noted that, at the same time, the first data buffer 102a will temporarily store a backup of the process packet to be used in re-transmission when an error occurs during the data transmission. The first PVD application layer 102d appends the header and the cyclic redundancy check (CRC) codes to the PCIe transaction layer packet and combines these data into a PVD packet for sending to the first PVD MAC layer 102e. Lastly, the first PVD MAC layer 102e appends the required framing, header, CRC and tail, which depends on the PVD PHY requirements, to the PVD packet and combine these data into a PVD MAC packet PVMP for transmitting to the first PVD PHY layer 103. Then, the first PVD PHY layer 103 generates a PVD physical signal PVS according to the PVD MAC packet PVMP and transmits the PVD physical signal PVS through a transmission medium 104.

Referring to FIG. 1A, in one embodiment, the PVD PHY layers 103 and 105 according to the embodiments of the invention may be implemented by the existing devices having a physical layer circuit such as: modulator-demodulator (modem), IP sharing device, router, or the like with minor modifications or without modification. In conclusion, by way of the above mentioned approaches, the design expense and the production cost of the distant PCIe extended system according to the embodiments of the invention can be greatly reduced. Of course, the PVD PHY layers 103, 105 can also be implemented by circuits designed by the research and development personnel or circuits having the physical layer to be developed in the future. Besides, the PVD PHY layers 103, 105 according to the embodiments of the invention may operate at various data transmission rates. For example, the PVD PHY layer 103 may be operating at 10 Mbit, 100 Mbit, one giga-bit or other higher transmission rate (or a transmission rate presets by a designer). The transmission medium 104 according to the embodiments of the invention utilizes a twisted pair cable or an optical fiber line, such as the existing commonly available: CAT-5, CAT-5e, CAT-6, or other transmission lines having higher transmission speed (speed presets by a designer), for transmission. As the cost of such transmission line is low, the embodiments of the invention can greatly reduce the production cost while achieving better transmission efficiency compared to the prior technique. Certainly, the embodiments according to the invention are not limited by these examples. Any existing commonly used transmission lines or other popular transmission lines to be developed in the future can also be used.

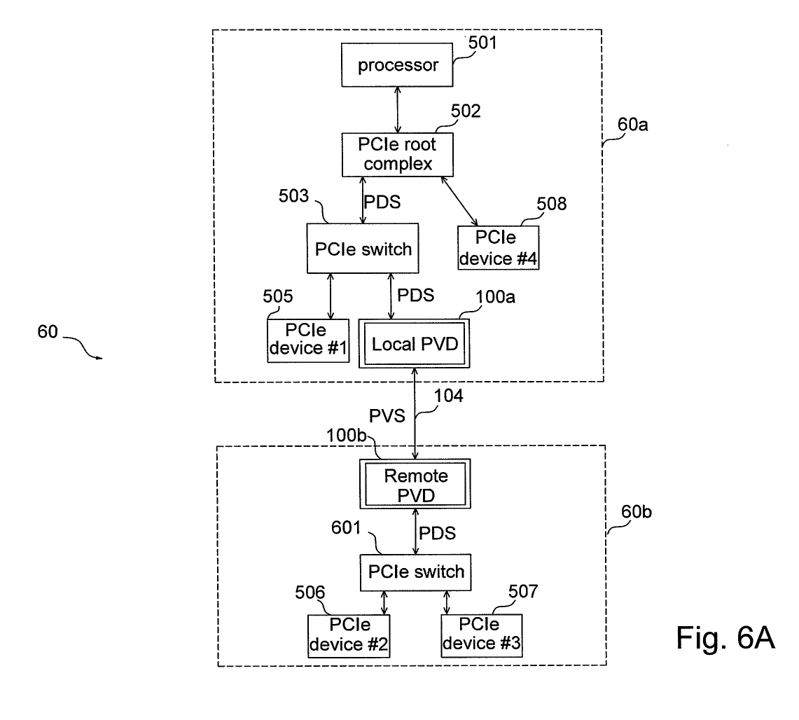

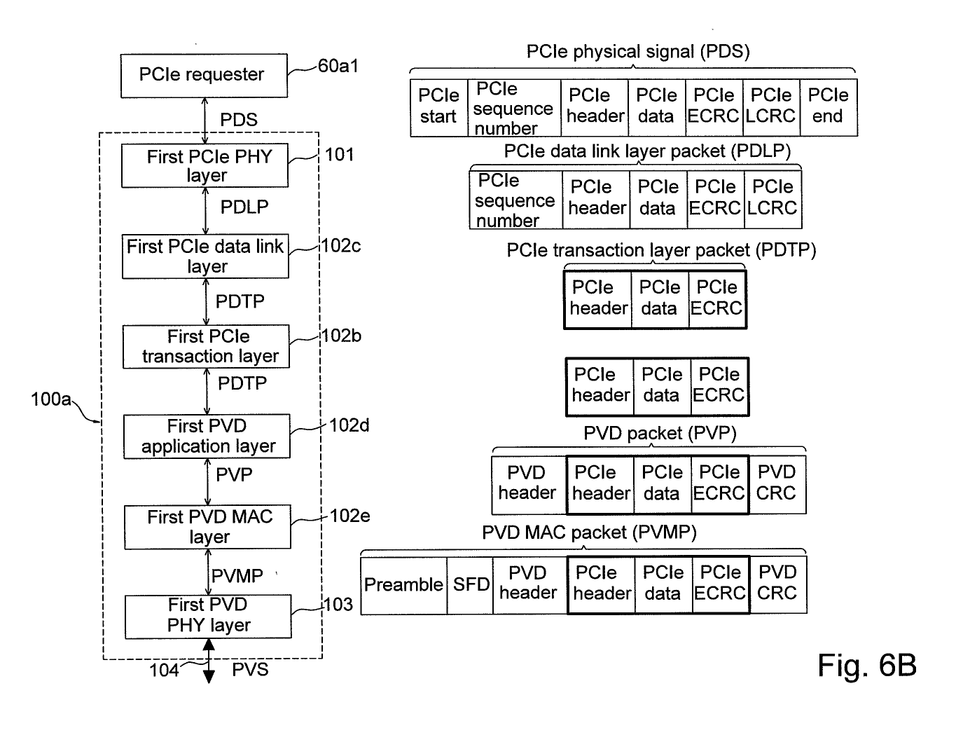

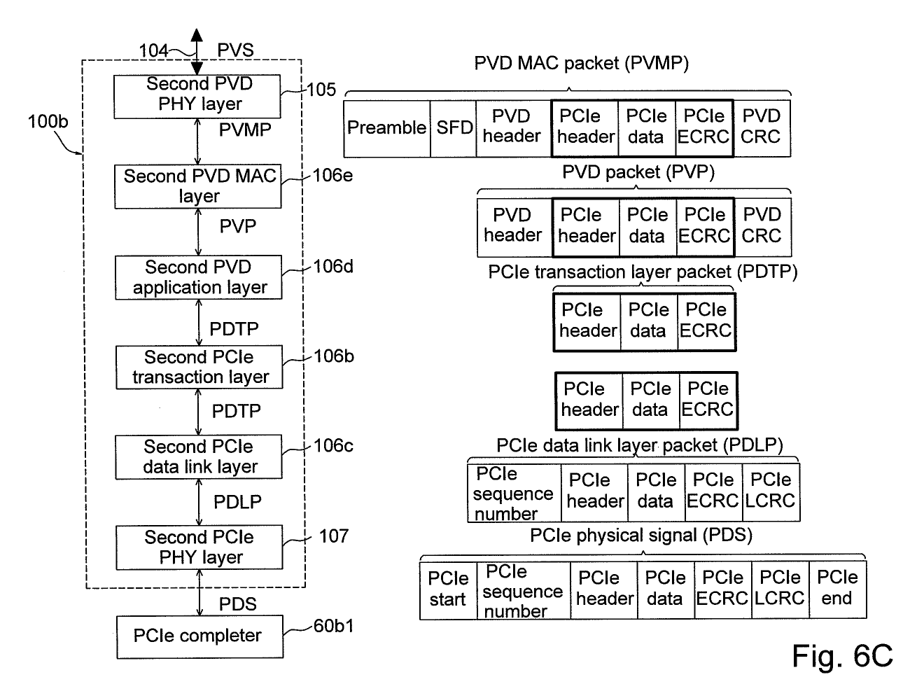

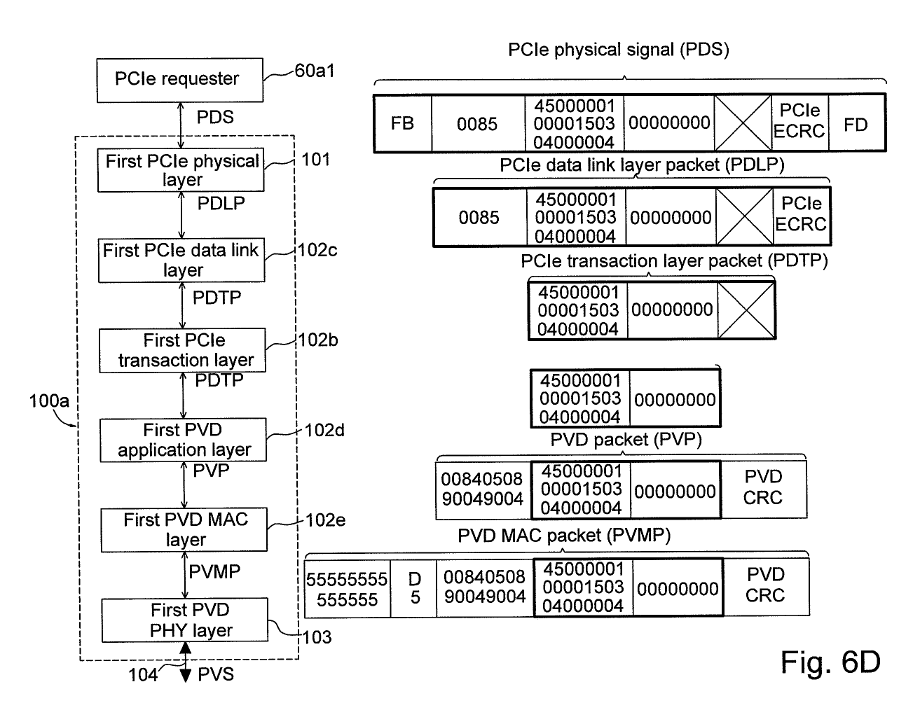

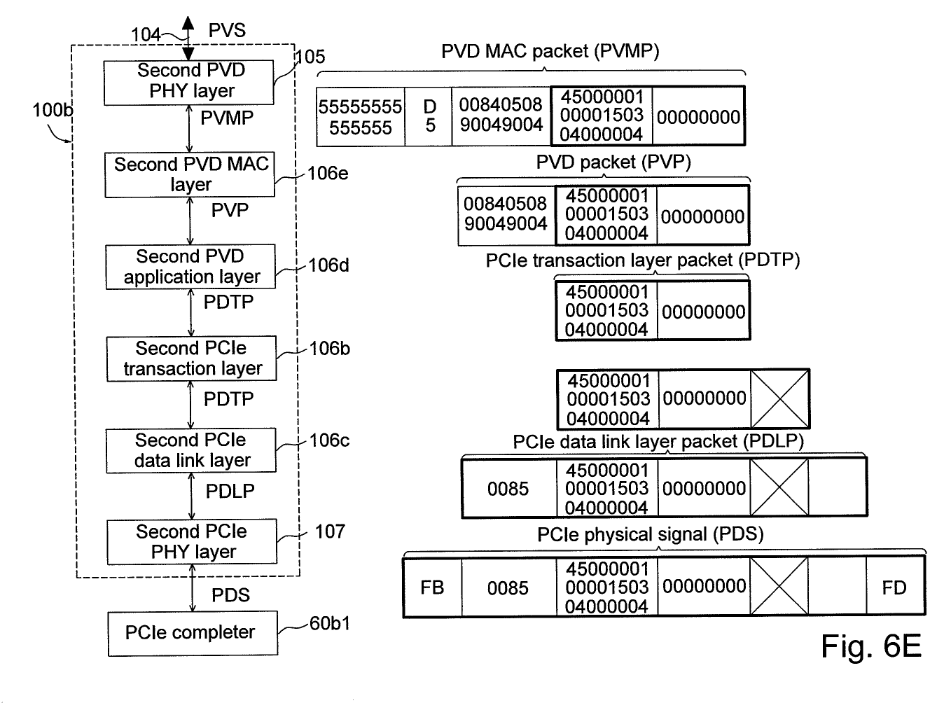

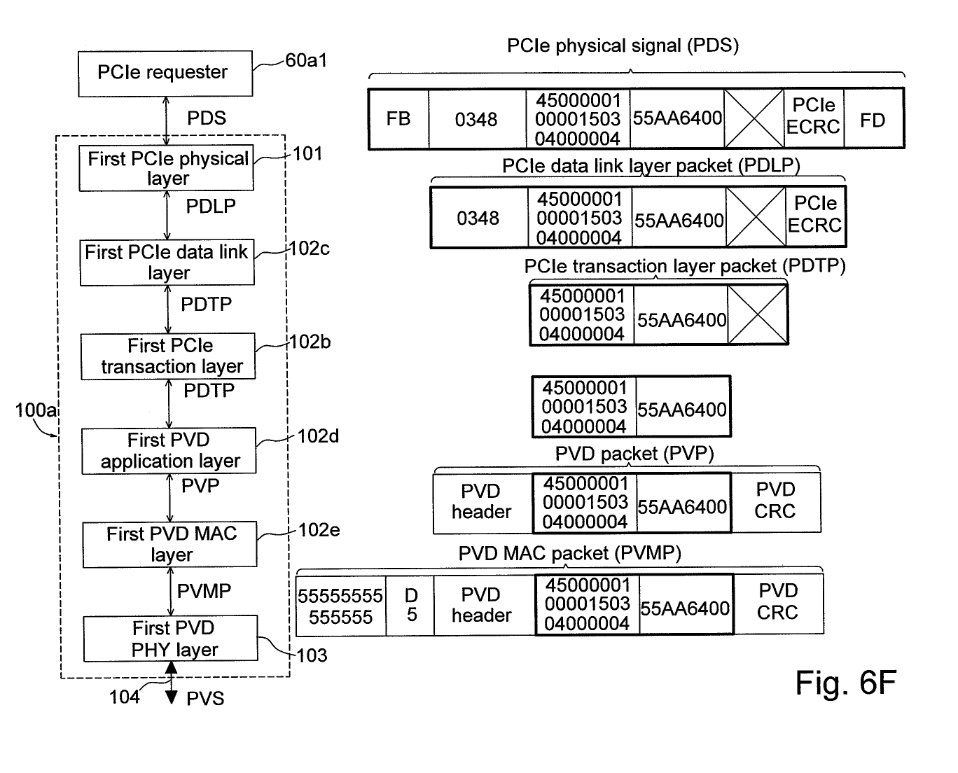

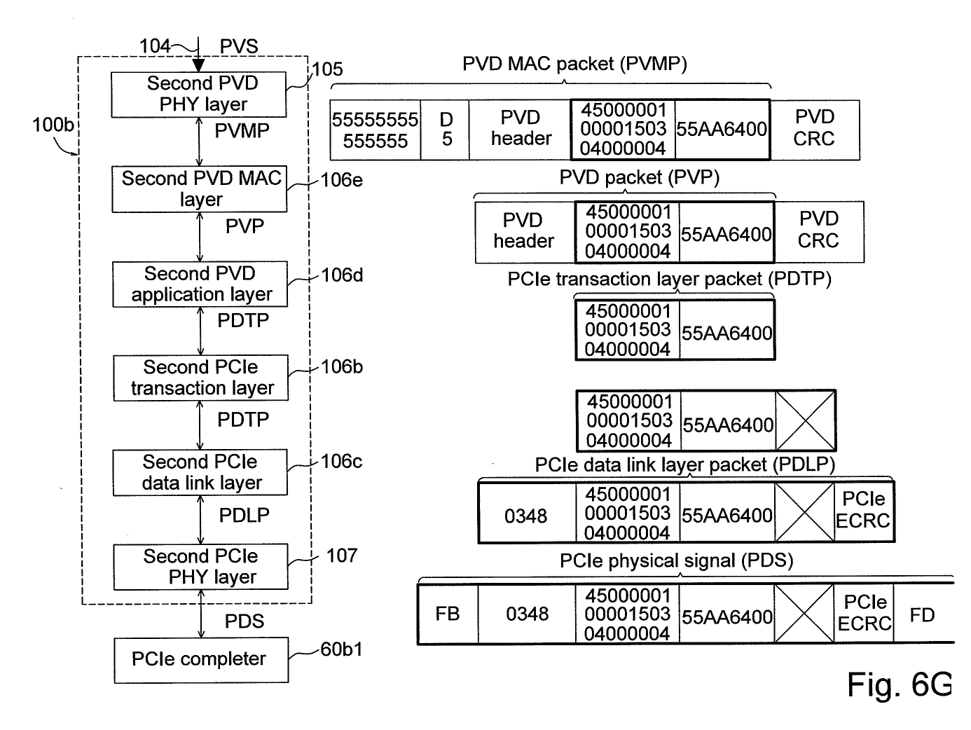

When the PVD physical signal PVS is transferred to the remote PVD 100b, the second PVD PHY layer 105 transfers the PVD MAC packet PVMP to the second signal converting circuit 106. The second signal converting circuit 106 according to one embodiment of the invention may be a signal converting circuit for converting the gigabit media independent (GMII) interface into PCIe interface. The second signal converting circuit 106 includes a second data buffer 106a, a second PCIe transaction layer 106b, a second PCIe data link layer 106c, a second PVD application layer 106d and a second PVD MAC layer 106e. The operating principle of the second signal converting circuit 106 is similar to the first signal converting circuit 102 of the local PVD 100a. It can be understood for those who are skilled in the art and will not be repeated hereinafter. After that, the second signal converting circuit 106 converts the PVD MAC packet PVMP to the PCIe data link layer packet PDLP. Lastly, the second PCIe PHY layer 107 restores the PCIe data link layer packet PDLP into the PCIe physical signal PDS and transfers the PCIe physical signal PDS to the PCIe completer (PCIe device)506 or 507 (shown in the FIG. 6A) of the remote terminal 60b for subsequent processing.

It should be noted that the local PVD 100a and the remote PVD 100b according to the embodiment of the invention can provide bi-directional transmission. For example, the PCIe physical signal PDS can also be received by the remote PVD 100b and transmitted to the local PVD 100a through the transmission medium 104. Then, the PCIe physical signal PDS is restored by the local PVD 100a. Therefore, the PCIe physical signal PDS may be completely restored in the local PVD 100b or the remote PVD 100a by the conversion of the signal converting circuits 102, 106. Furthermore, the embodiments of the invention utilize the transmission medium 104 (a twisted pair cable or an optical fiber line) for data transmission to achieve the effect of long distance transmission between the local PVD 100a and the client PVD 100b and to resolve the data transmission distance limitation in the prior art.

Furthermore, the remote PVD 100b may determine if the transmitted data is correct or not according to the link data protection codes, such as cyclic redundancy check codes, of the received data link layer packet PDLP. When the data is incorrect, the remote PVD 100b can transmit an error message to the local PVD 100a through the transmission medium 104. Then, the local PVD 100a re-processes the data that is temporarily stored in the first data buffer 102a and transmits the data to the remote PVD 100b through the transmission medium 104 for another check. This process repeats itself until the data is correctly received.

According to another embodiment of the invention, the above mentioned link data protection code may be an error correction code (ECC). When using the error correction code, both of the local PVD 100a and the remote PVD 100b can omit the data buffers 102a, 106a as shown in FIG. 1B. FIG. 1C shows the local PVD 100a and the remote PVD 100b may perform data correction based on the error correction code without using the data buffers 102a, 106a. Therefore, the area of the circuits to implement the embodiments of the invention can be reduced and the production cost can be reduced.

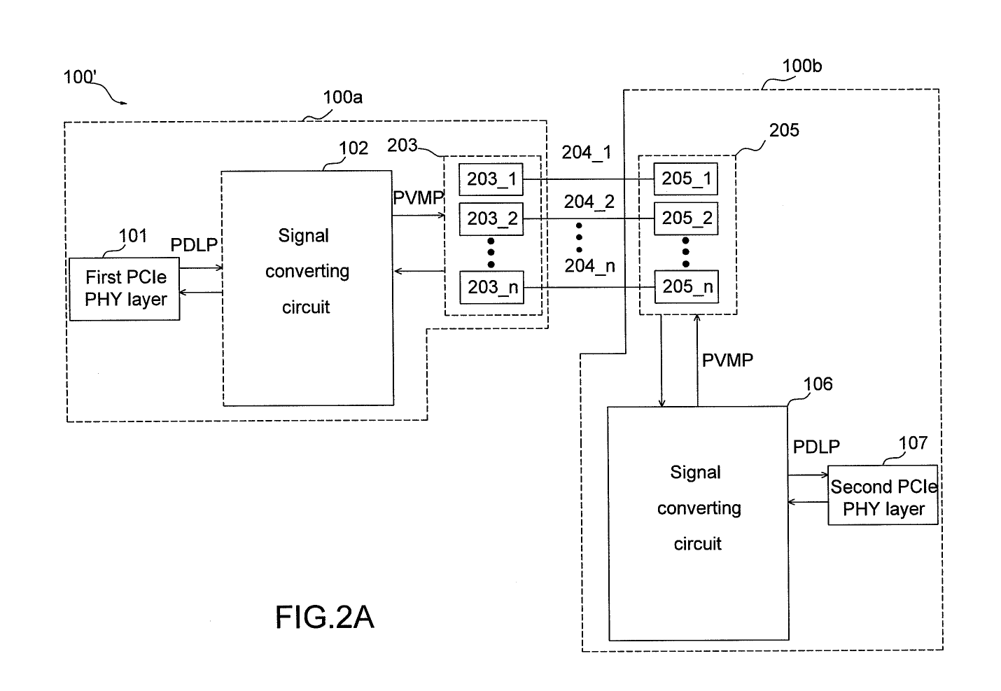

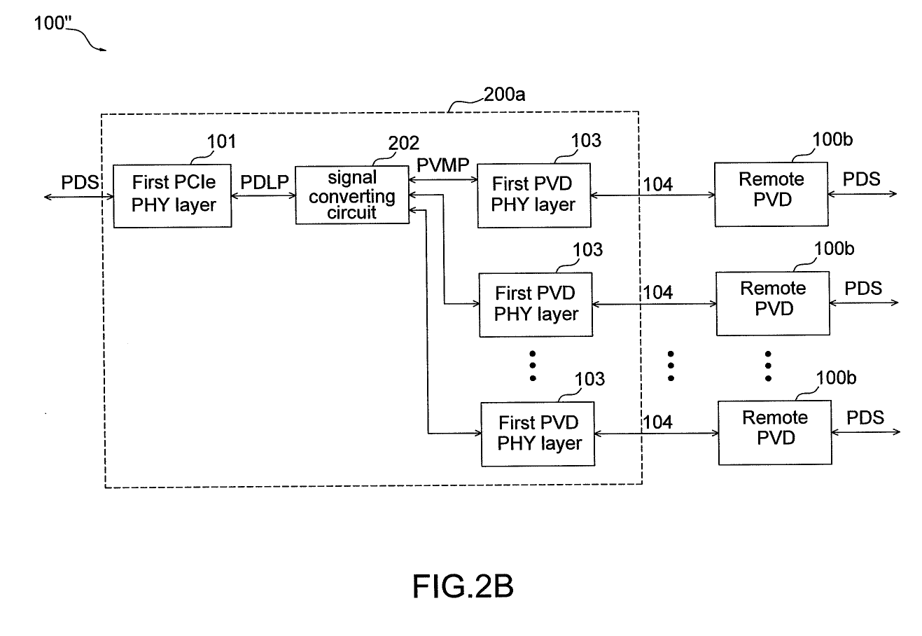

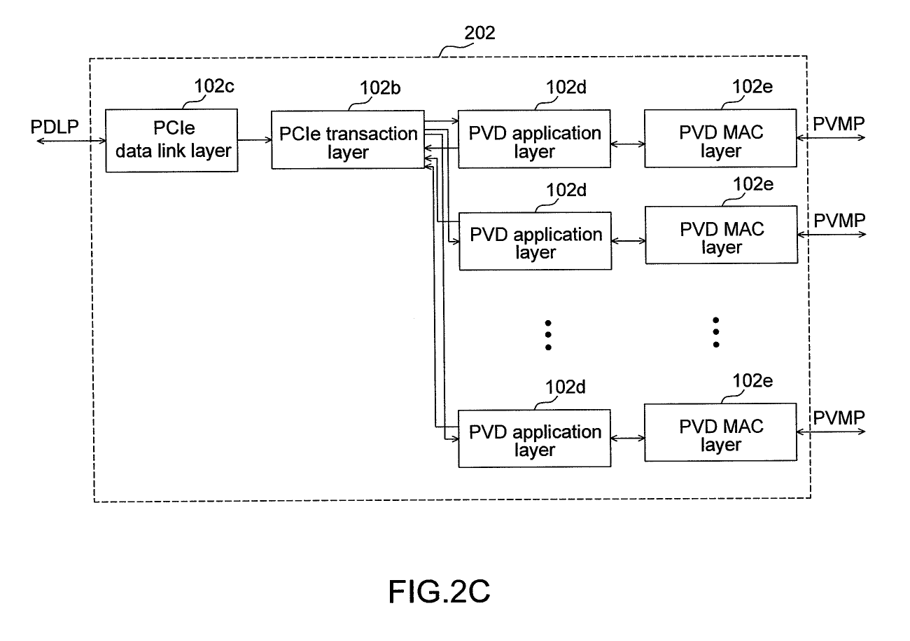

FIG. 2A shows a schematic diagram illustrating the distant PCIe extended system 100′ according to another embodiment of the invention. The operating principle of the distant PCIe extended system 100′ is similar to the above mentioned embodiments of the invention. The difference lies in the first PVD PHY layer 203 of the distant PCIe extended system 100′ that can include n number of (where n is a positive integer and n is less than infinity) sub-PVD PHY layer circuits 203_1 ˜203_{—}n. According to the architecture of the embodiment, the distant PCIe extended system 100′ can divide a relatively large PVD MAC packet PVMP into n number of relatively small PVD MAC packets and perform data transmission through n number of transmission media 204_1˜204_{—}n, respectively. Similarly, the n number of sub-PVD PHY layer circuits 205_1 ˜205_{—}n of the second PVD PHY layer 205 of the remote PVD 100b receive the n number of relatively small PVD MAC packets and combine these received small PVD MAC packets, and then provide the combined relatively large PVD MAC packet PVMP to the second signal converting circuit 106 for data conversion. Hence, the distant PCIe extended system 100′ according to the embodiment of the invention can increase the data transmission speed and the transmission efficiency. Transmitting a packet between the local PVD 100a and the remote PVD 100b through the approach of dividing the packet can resolve the network congestion problem especially when transmitting a large quantity of packets.

FIG. 2B shows a schematic diagram illustrating the distant PCIe extended system 100″ according to another embodiment of the invention. The operating principle of the distant PCIe extended system 100″ is similar to the above mentioned embodiments of the invention. Referring to FIGS. 2B and 2C, the difference lies in the first signal converting circuit 202 of the distant PCIe extended system 100″ that can include n number of (where n is a positive integer and n is less than infinity) PVD application layers 102d and PVD MAC layers 102e. In the embodiment, the distant PCIe extended system 100″ also includes n number of PVD PHY layers 103, transmission media 104 and remote PVDs 100b. According to the architecture of the embodiment, the PCIe transaction layer 102b can decode the PCIe transaction layer packet and decide to send the packet to one of the PVD application layers 102d then send to correspondent PVD MAC layer 102e. The correspondent PVD MAC layer 102e receives the PVD packet and transfers it to the PVD MAC packet PVMP, and then send the PVD MAC packet PVMP to the correspondent PVD PHY layer 103. The correspondent PVD PHY layer 103 transfers the PVD MAC packet PVMP to the PVD physical signal PVS, and then sends the PVD physical signal PVS to the correspondent transmission medium 104. The correspondent remote PVD 100b receives the PVD physical signal PVS and transfers it into PCIe physical signal PDS in the same procedure which is described in previous embodiment.

It should be noted that, through the description of the above mentioned examples, those who are skilled in the art should be able to understand that the remote PVD 100b of the above embodiments of the invention may also transmit data to the local PVD 100a for bi-directional data transmission and thus detail descriptions will not be repeated hereinafter. Besides, the information transmitted by the distant PCIe extended system of the above embodiments of the invention is processed via the signal complying with the PCIe specification. Of course, the information transferred and processed by the distant PCIe extended system according to the embodiments of the invention may include information according to various different specifications or formats, such as: instruction, data, image, audio, program code, control code, or any combination of the above, information according to various currently existing specifications, or information according to various specifications to be developed in the future.

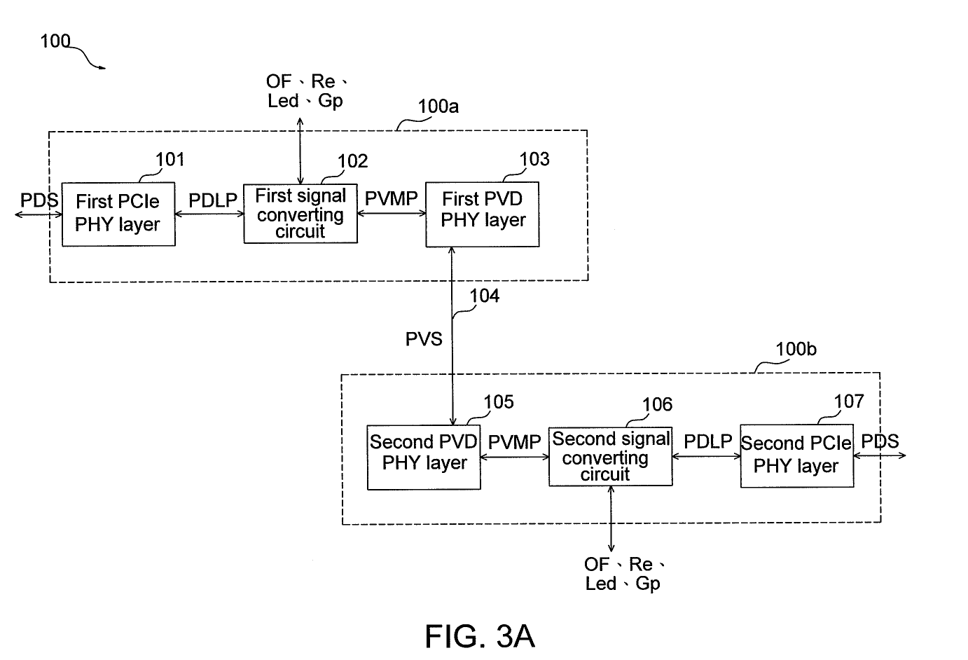

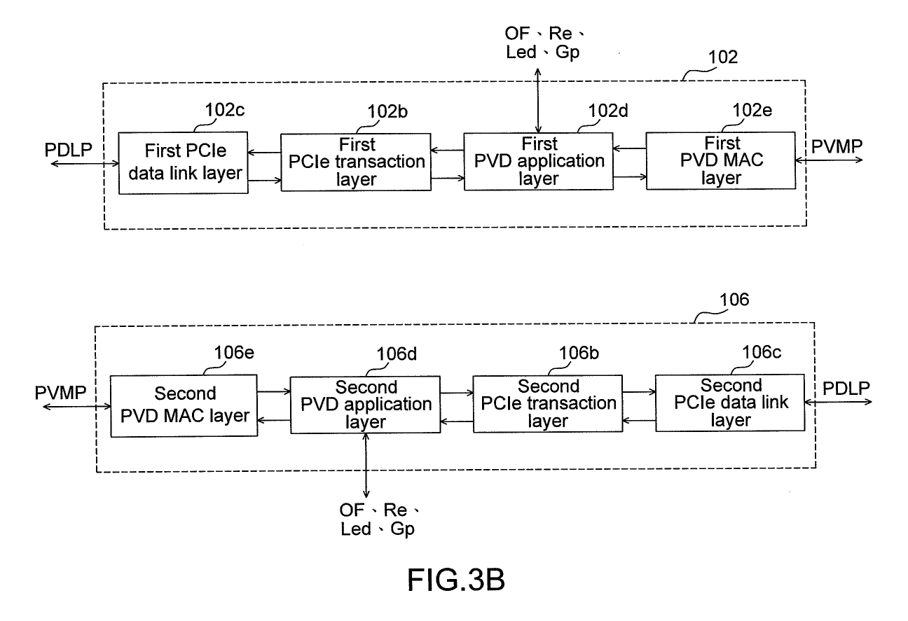

Furthermore, the distant PCIe extended system according to the embodiments of the invention may process other signals and be provided with the functionality of remote control and remote management. The first signal converting circuit 102 of the local PVD 100a shown in FIG. 3A may process other signals through at least one signal path of the transmission medium 104 to communicate with the remote PVD 100b. It should be noted that the second signal converting circuit 106 of the remote PVD 100b may also process the signals through the at least one signal path of the transmission medium 104 to communicate with the local PVD 100a 100a. Specifically, as shown in FIG. 3B, the signals can be received and processed by the first PVD application layer 102d and the second PVD application layer 106d. The signals may be On/Off (OF), reset signal (Re), light emitting diode indicating signal (Led), wake up signal (WAKE), general purpose I/O (GPIO), or any combination of the above. Those who are skilled in the art should be able to understand how to utilize these signals to perform remote control and remote management and thus detail descriptions will not be repeated hereinafter.

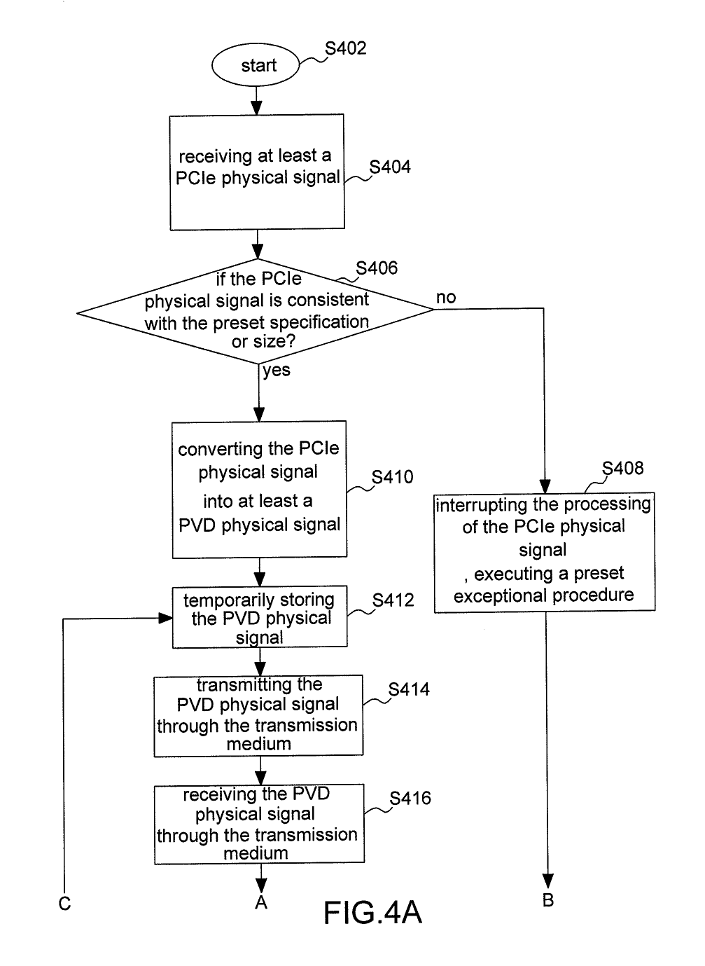

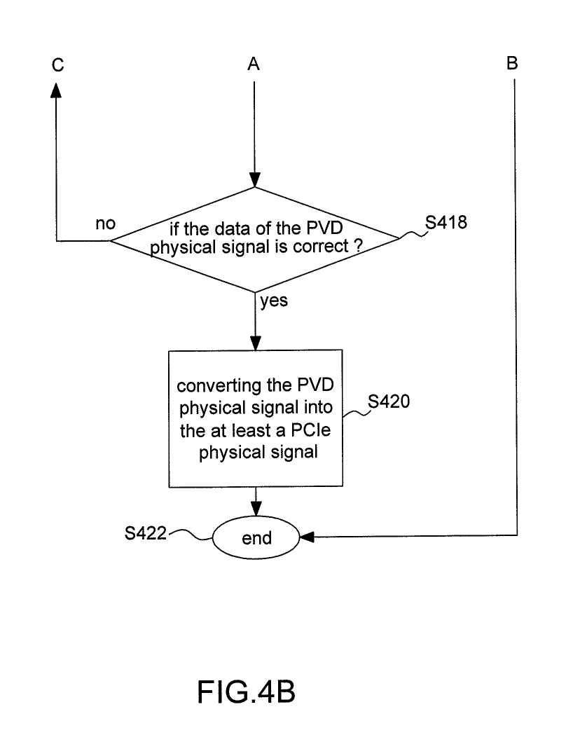

FIGS. 4A and 4B show flow charts illustrating the distant bus extended method according to one embodiment of the invention. It comprises the following steps:
Step S402: start;
Step S404: receiving at least a PCIe physical signal;
Step S406: determining if the PCIe physical signal is consistent with the preset specification or size, and jumping to Step S410 if yes, or jumping to Step 408 if not;
Step S408: interrupting the processing of the PCIe physical signal, executing a preset exceptional procedure, such as: executing the target-abort procedure preset in the PCIe physical signal according to one embodiment, and then jumping to Step S422;
Step 410: converting the PCIe physical signal into at least a PVD physical signal;
Step 412: temporarily storing the PVD physical signal;
Step 414: transmitting the PVD physical signal through the transmission medium;
Step 416: receiving the PVD physical signal through the transmission medium;
Step 418: determining if the data of the PVD physical signal is correct or not according to the preset coding, and jumping to Step S420 if yes, or jumping to Step 412 if not;
Step 420: converting the PVD physical signal into the at least a PCIe physical signal; Step S422: end.

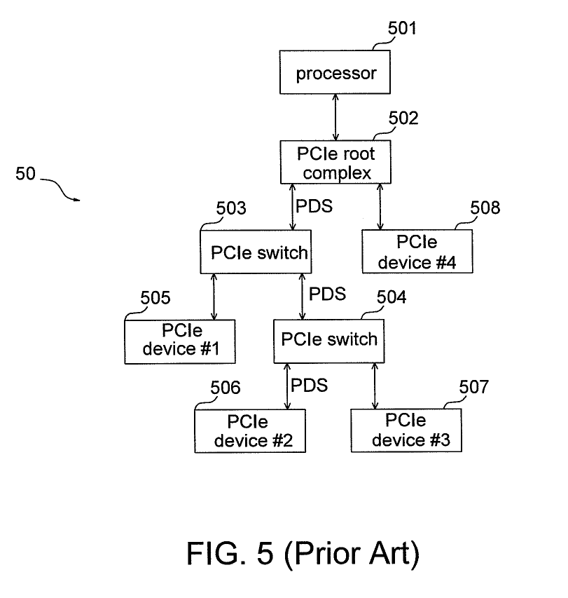

FIG. 5 shows a schematic diagram illustrating a general PCIe computer system according to prior art. The prior PCIe computer system 50 includes a processor 501, a PCIe root complex 502, PCIe switches 503˜504 and PCIe devices 505˜508. The detailed operation principle of the prior PCIe computer system 50 can be understood for those who are skilled in the art and will not be repeated hereinafter. The prior PCIe computer system 50 can use this structure shown in the FIG. 5 to achieve control or communicate mechanism between the processor 501 and the PCIe devices 505˜508. For example, the processor 501 generates a PCIe physical signal PDS to control peripheral device#2 506 through a signal path formed by the route complex 502 and the switches 503, 504. However, a distance limitation of the signal path prevents the processor 501 from effectively transmitting the PCIe physical signal PDS.

For solving this problem, one embodiment of a distant PCIe extended computer system 60 based on prior PCIe link system is disclosed as shown in FIG. 6A. The distant PCIe extended computer system 60 includes a host computer 60a and a remote terminal 60b. The distant PCIe extended computer system 60 may set far end peripheral devices, such as the PCIe devices 505˜507, in the remote terminal 60b. The distant PCIe extended computer device 60 uses two PVDs 100a and 100b to transmit a PCIe signal through a transmission medium 104 (such as Cat. 5e). As shown in FIG. 6A, a local PVD 100a generates a PVD physical signal PVS according to a received PCIe physical signal PDS and transmits the PVD physical signal PVS to a remote PVD 100b through the transmission medium 104, where the PVD physical signal PVS is constructed to conform to a specification of the transmission medium 104 and capable of being transmitted through the transmission medium 104. Then, the remote PVD 100b receives the PVD physical signal PVS and reconstructs the PVD physical signal PVS into the PCIe physical signal PDS. Thus, the processor 501 may use PCIe physical signal PVS to communicate with or control the far end PCIe devices#2˜3 506˜507, such as a far end mouse, keyboard and so on. Therefore, the distant PCIe extended computer system 60 can achieve a long distance signal transmission.

Detailed description of the distant PCIe extended computer system 60 is described below.

FIGS. 6B and 6C show a data flow diagram between the local PVD 100a and the remote PVD 100b. At first, a PCIe requester 60a1 sends a PCIe physical signal PDS including a PCIe start, a PCIe sequence number, a PCIe header, a PCIe data, a PCIe ECRE, a PCIe LCRC and a PCIe end. The PCIe requester 60a1 can be a PCIe root complex, PCIe switch or a PCIe device. A first PCIe PHY layer 101 decodes the PCIe physical signal PDS and strips the PCIe start and PCIe end frame fields to generate a PCIe data link layer packet PDLP. Then, a first PCIe data link layer 102c receives the PCIe data link layer packet PDLP and checks the PCIe LCRC field in the PCIe data link layer packet PDLP for any errors. If there is no LCRC error, the first PCIe data link layer 102c strips the PCIe sequence number and PCIe LCRC fields from the PCIe data link layer packet PDLP to let a PCIe transaction layer packet (TLP (Transaction Layer Packet) PDTP remain, and then forwards the PCIe transaction layer packet PDTP to a first PCIe transaction layer 102b. The PCIe transaction layer packet PDTP includes the PCIe header, PCIe data and PCIe ECRE fields, where the PCIe ECRE field is optional and may be omitted from the PCIe transaction layer packet PDTP. Thereafter, the first PCIe transaction layer 102b receives the PCIe transaction layer packet PDTP. In one embodiment, some PCIe transaction layer packets PDTP only contain the PCIe header and do not contain the PCIe data field. In another embodiment, if the ECRC field exists in the PCIe packet Pci, the first PCIe transaction layer 102b may check for ECRC errors and may strip the ECRC field to reduce the total packet size of the PCIe transaction layer packet PDTP, or the first PCIe transaction layer 102b may not strip the ECRC field.

As an exemplary example shown in the FIG. 6B, the resultant PCIe transaction layer packet PDTP, including the PCIe header, the PCIe data and the PCIe ECRC, is forwarded to the first PVD application layer 102d and a first PVD MAC layer 102e. For transmitting through the transmission medium 104, the first PVD application layer 102d assembles a PVD header (frame header) and a PVD CRC (optional) with the PCIe transaction layer packet PDTP to generate a PVD packet PVP, and then the first PVD MAC layer 102e assembles a preamble and a SFD with the PVD packet PVP to generate a PVD MAC packet PVMP. After that, a first PVD PHY layer 103 transmits the PVD physical signal PVS to the client terminal 60b through the transmission medium 104.

Please note that, the above mentioned PVD header and the PVD CRC are used as preset flags to be identified by the second PVD MAC layer 106e and second PVD application layer 106d. The preamble and the SFD are used as codes to allow the PVD physical signal PVS to be transmitted through the transmission medium 104.

After that, referring to FIG. 6C, a second PVD PHY layer 105 of the remote terminal 60b receives the PVD physical signal PVS and transmits it to a second PVD MAC layer 106e and a second PVD application layer 106d. The second PVD MAC layer 106e checks for any errors of the received PVD MAC packet PVMP, and strips the preamble and SFD fields to generate the PVD packet PVP. Then, the second PVD application layer 106d identifies the PVD packet PVP according to the PVD header and the PVD CRC. If the data of the PVD header and the PVD CRC are valid, the second PVD application layer 106d strips the PVD header and the PVD CRC to generate the PCIe transaction layer packet PDTP. A second PCIe transaction layer 106b receives the PCIe transaction layer packet PDTP. In one embodiment, if the PCIe ECRC exists in the PCIe transaction layer packet PDTP, the second PCIe transaction layer 106b may check for ECRC error and modify the Error/Poisoned flag of the PCIe transaction layer packet PDTP. Thereafter, the second PCIe transaction layer 106b forwards the PCIe transaction layer packet PDTP to a second PCIe data link layer 106c. The second PCIe data link layer 106c assembles the PCIe sequence number and the PCIe LCRC with the PCIe transaction layer packet PDTP to reconstruct the PCIe data link layer packet PDLP. A second PCIe physical layer 107 receives the PCIe data link layer packet PDLP and concatenates a PCIe start field and a PCIe end frame field to the PCIe data link layer packet PDLP to reconstruct the PCIe physical signal PDS. Then, a PCIe completer receives the PCIe physical signal PDS and controls peripheral devices according to the PCIe physical signal PDS. The PCIe completer 60b1 can be a PCIe root complex, PCIe switch or a PCIe device. After this operation, the PCIe physical signal PDS is encoded and differentially transmitted over the PCIe link, and thus the distant PCIe extended computer system 60 according to the present invention can achieve the purpose of dramatically increasing the transmission distance and transmitting PCIe physical signal PDS through low cost transmission line, such as twisted pair cable.

FIGS. 6D and 6E show an exemplary example of data flow between the local PVD 100a and the remote PVD 100b. In this example, parameters are set as follows: the PCIe start=FB, the PCIe sequence number=0085, the PCIe Header=450000010000150304000004, the PCIe data=00000000, the PCIe ECRC=none, the PCIe end=FD, the PVD header=0084050890049004, the preamble=55555555555555 and the SFD=D5. Further, FIGS. 6F and 6G show another exemplary example of data flow between the local PVD 100a and the remote PVD 100b. The data numbers of FIGS. 6F and 6G are about equal to those of FIGS. 6D and 6E. The differences are that PCIe sequence number is set to be 0348, PCIe data is set to be 55AA6400, and PVD header is set to be optional in FIGS. 6F and 6G Those who are skilled in the art can understand the operations of these examples according to above description so that the operations will not be repeated hereinafter. Also, the above data numbers are only examples but the invention is not limited to these examples.

Please note that, the embodiments of the invention of the interior circuit of PCIe PHY layer 101 (107), the signal converting circuit 102 (106) and the PVD PHY layer 103 (105), shown in FIGS. 1A˜3, may be designed to have structures different from the block diagram. In one embodiment, the PCIe PHY layer 101 (107) may be set to include the PCIe PHY layer 101 (107) and the PCIe data link layer 102c (106c) as shown in FIGS. 6B˜6G, or to include the PCIe PHY layer 101 (107), the PCIe data link layer 102c (106c) and the PCIe transaction layer 102b (106b) as shown in FIGS. 6B˜6G. The signal converting circuit 102 (106) may be set to include the PVD application layer 102d (106d) and the PVD MAC layer 102e (106e). Further, the PCIe data link layer signal PDLP, shown in FIGS. 1A˜3, may be set to include the PCIe header and the PCIe data as shown in FIGS. 6B˜6G, or include the PCIe header, the PCIe data and the PCIe ECRE as shown in FIGS. 6B˜6G. The PVD MAC packet PVMP, shown in FIGS. 1A-3, may be set to include the preamble, the SFD, the PVD header, the PCIe header, the PCIe data and the PVD CRC, or include the preamble, the SFD, the PVD header, the PCIe header, the PCIe data, the PCIe ECRC and the PVD CRC.

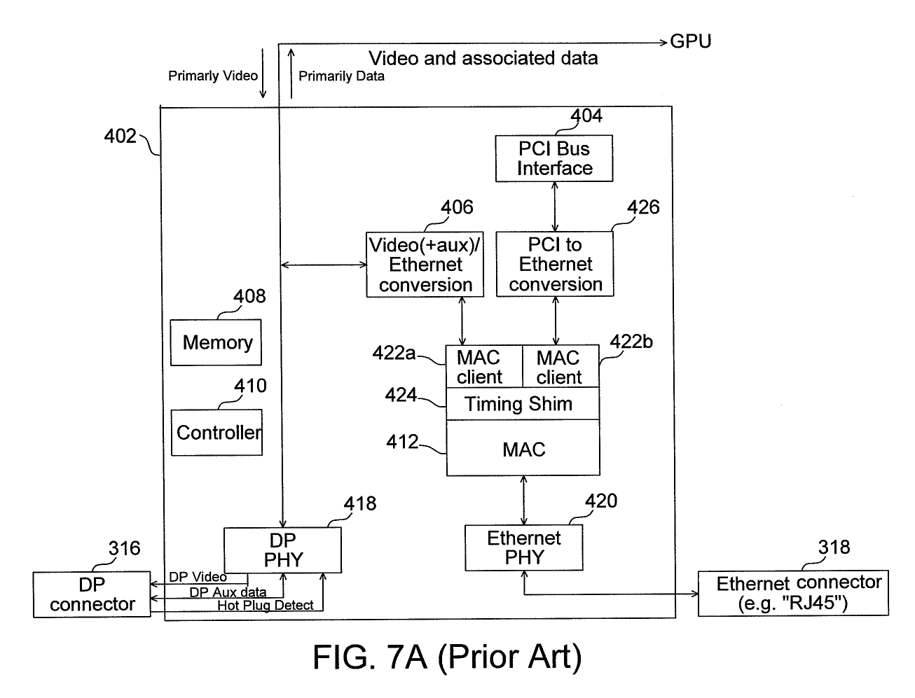

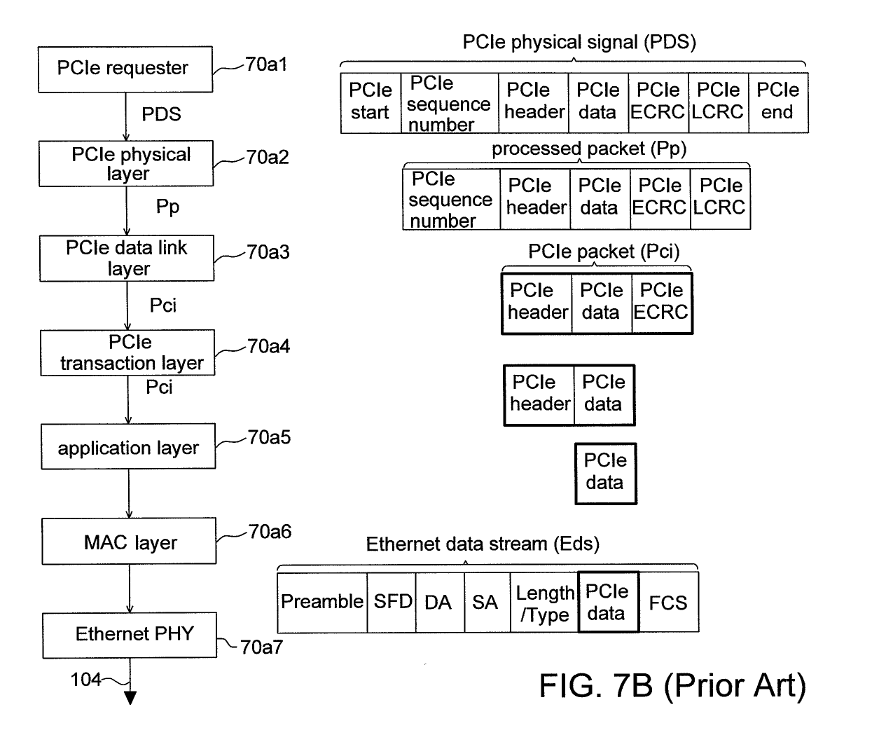

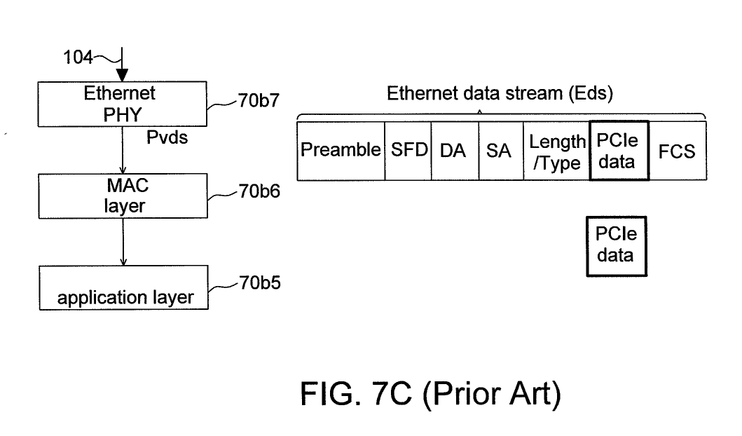

It should be noted that the embodiments of the present invention are different from conventional LAN subsystems, such as one described in FIG. 7A of US Publication Patent Application Ser. No. 2008/0285576 publicized on Nov. 20, 2008 by Teener et al. FIG. 7A shows a schematic diagram illustrating the prior LAN subsystem. FIGS. 7B and 7C show one example of a data flow diagram, depicted by a person skilled in the art, of the prior LAN subsystem shown in FIG. 7A, where the data flow at least passes through PCI Bus 404, Ethernet conversion 426, MAC units 422b, 424, 412 and Ethernet PHY 420. Referring to FIG. 7B, a PCIe requester 70a1 receives an incoming PCIe data stream Pds including a PCIe start, a PCIe sequence number, a PCIe header, a PCIe data, a PCIe ECRE, a PCIe LCRC and a PCIe end. Then, a PCIe physical layer 70a2, a PCIe data link layer 70a3, a PCIe transaction layer 70a4 and an application layer 70a5 disassemble the PCIe data stream Pds into a PCIe data. Then, the MAC layer 70a6 assembles preamble, SFD, DA, SA, Length/Type code and FCS fields with the PCIe data to generate an Ethernet data stream Eds, and an Ethernet PHY 70a7 transmits the Ethernet data stream Eds to another Ethernet PHY 70b7 shown in FIG. 7C through a twisted pair cable 104. Thereafter, another MAC layer 70b6 disassembles the Ethernet data stream Eds into the PCIe data and forwards to another application layer 70b5 for use. Comparing FIGS. 7B and 7C with FIGS. 6B and 6C, it is therefore clear that the data format and the processing method of the prior LAN subsystem are different from those of the distant PCIe extended computer system 60 of the embodiments of the present invention. The prior LAN subsystem is at least not reconstructing data streams back to the PCIe physical signal (PDS).

It should be noted that a PCIe Ethernet controller is not a PCIe switch device (as shown in FIG. 5, PCIe switch 503 or 504). Thus the transaction Layer 70a4 shown in FIG. 7B of the ultimate targeted device, PCIe Ethernet controller, always checks for ECRC errors and strips the ECRC field, but the embodiments of the invention doesn't. Further, the prior application layer 70a5 (70b5) can be any other prior arbitration layer instead. In the data flow shown in FIG. 7B, the PCIe header is stripped by the arbitration layer and only PCIe data remains. Then, the payload of memory transactions (PCIe data) can be forwarded to the MAC Layer 70a6. Other like Configuration, IO, and Message transactions are terminated forwarding to the MAC Layer. The above mentioned prior devices have the same difference, which is not reconstructing data streams back to the PCIe physical signal PDS, with the distant PCIe extended computer system 60 of the embodiments of the present invention.

Further, another prior art discloses that a PCIe requester differentially transmits a PCIe data packet on a transmitting frequency of 2.5 GHz or 5.0 GHz directly to a PCIe completer through a twisted pair cable, such as Cat. 5e. However, the twisted pair cable (such as Cat. 5e) is not designed for such high working frequency so that the propagation distance of the PCIe data packet is short and limited. The embodiments of the invention can overcome this problem.

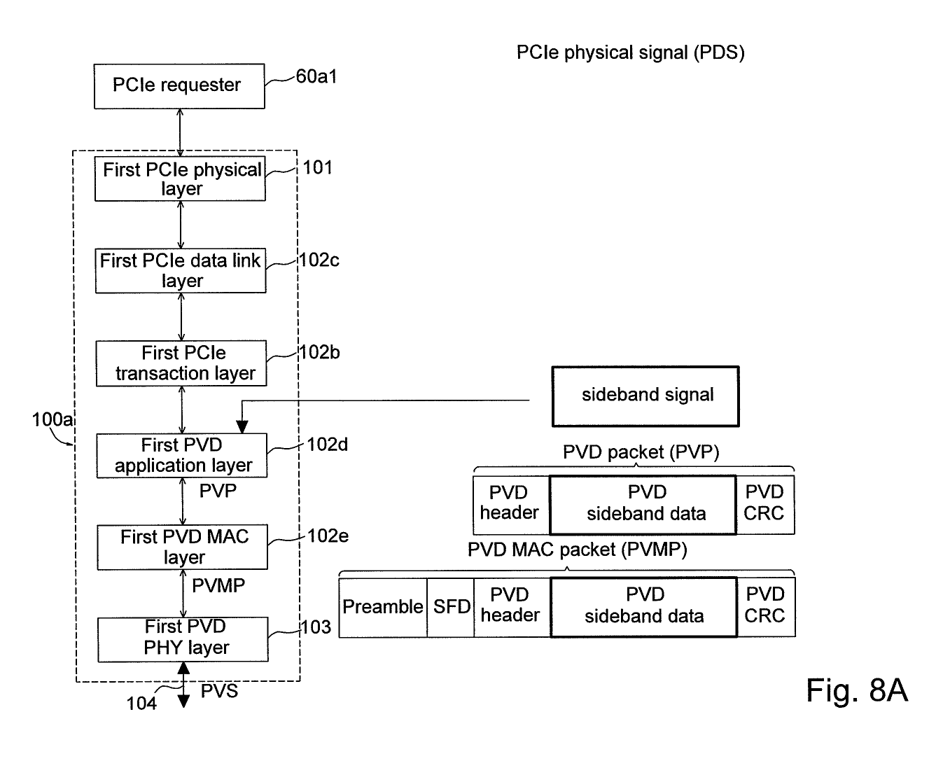

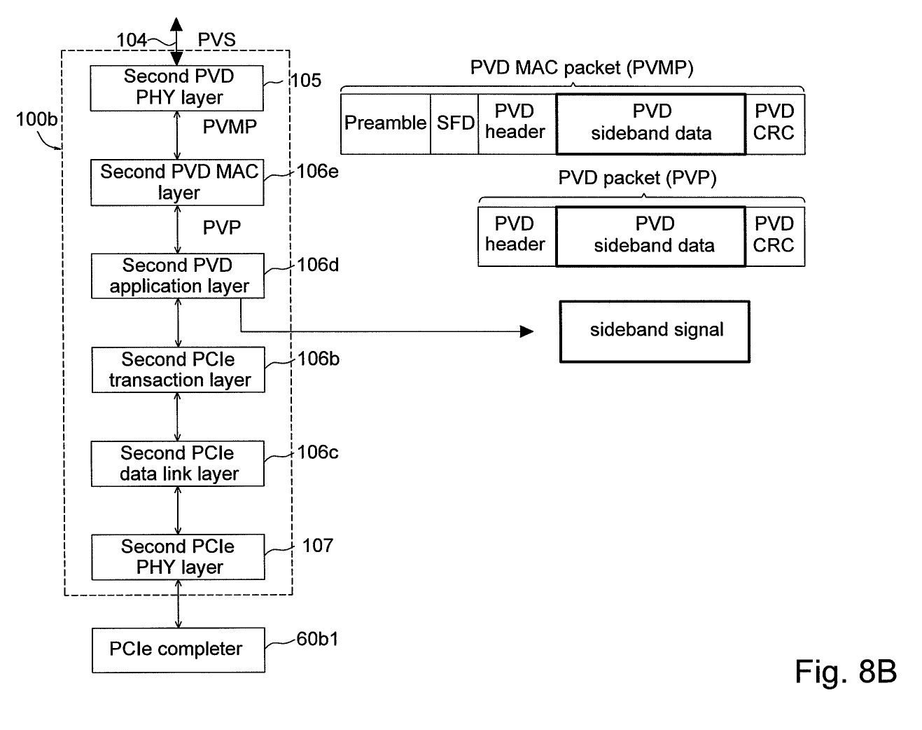

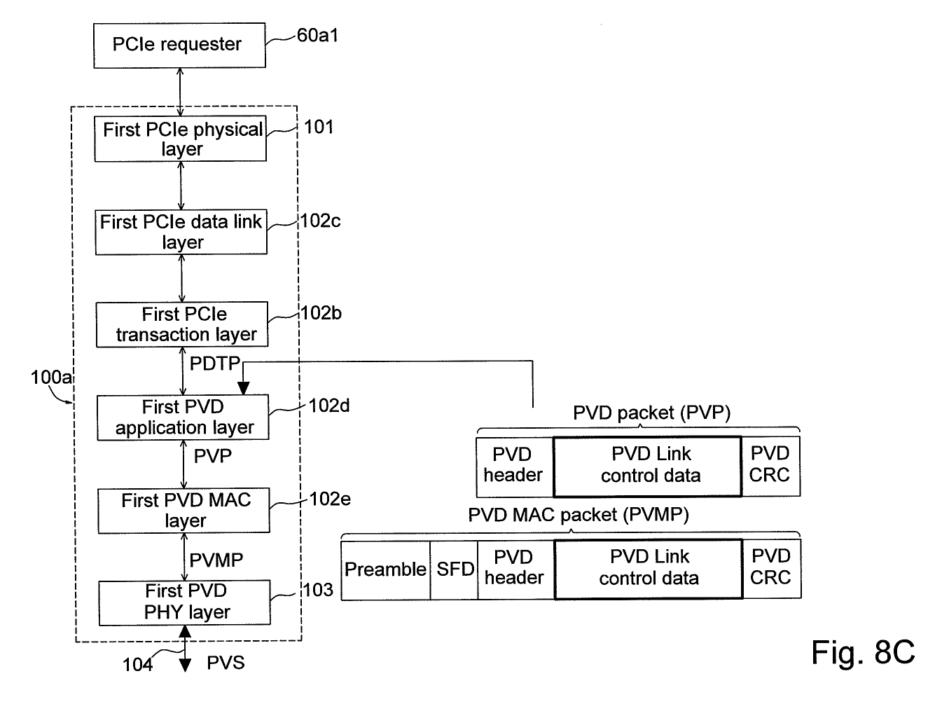

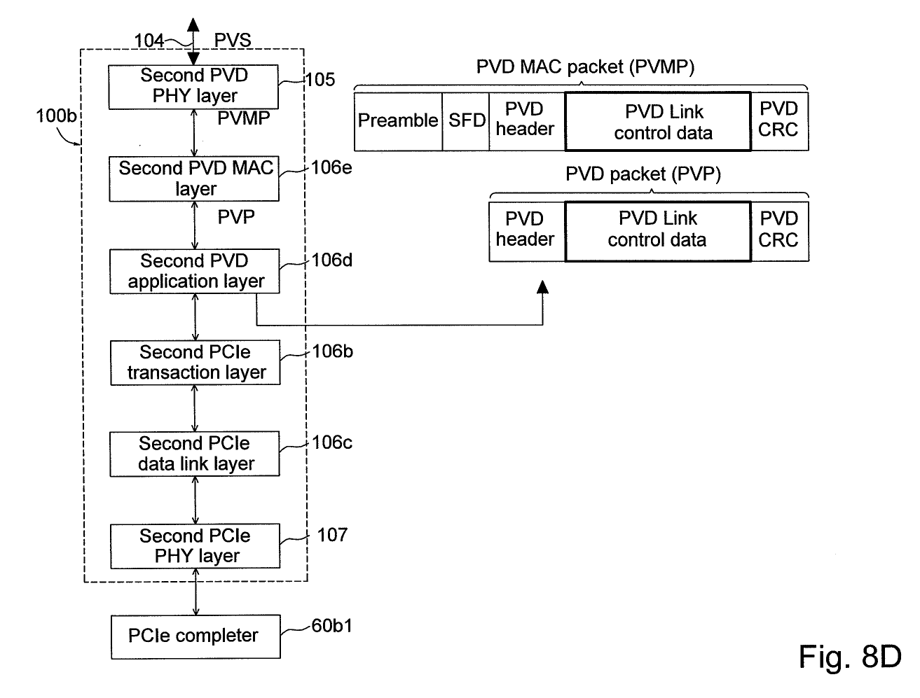

FIGS. 8A and 8B show an embodiment of the invention of the side band signals OF, Re,

Led and GP shown in FIG. 3A. The sideband signal may be transmitted to the first PVD application layer 102d. The first PVD application layer 102d and the first PVD MAC layer 102e assembles preamble, SFD, PVD header and PVD CRC with the sideband signal to generate a PVD MAC packet PVMP. The first PVD PHY layer 103 transforms the PVD MAC packet PVMP into the PVD physical signal PVS. The first PVD PHY layer 103 transmits the PVD physical signal PVS to the second PVD PHY layer 105 through the transmission medium 104. Then, the second PVD PHY layer 105 transforms the PVD physical signal PVS into the PVD MAC packet PVMP. The second PVD MAC layer 106e and the second PVD application layer 106d disassemble the PVD MAC packet PVMP into the sideband signal. Thus the sideband signal can be transmitted through the transmission medium 104 to communicate with or control operations of a far end client peripheral device. In another embodiment, as shown in FIG. 8C, the distant PCIe extended computer system 60 can transmit a PVD Link control data to a far end peripheral device for extra control use. The detailed operation of transmitting the PVD Link control data can be understood through the above description for those who are skilled in the art and will not be repeated hereinafter.

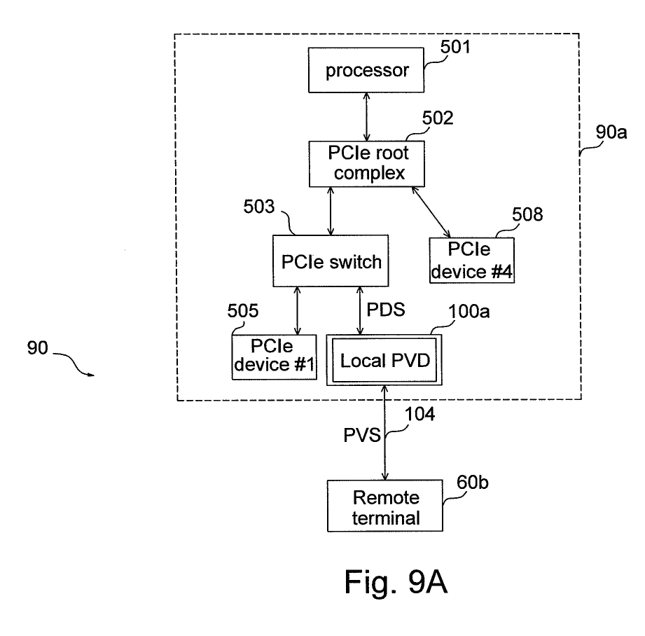

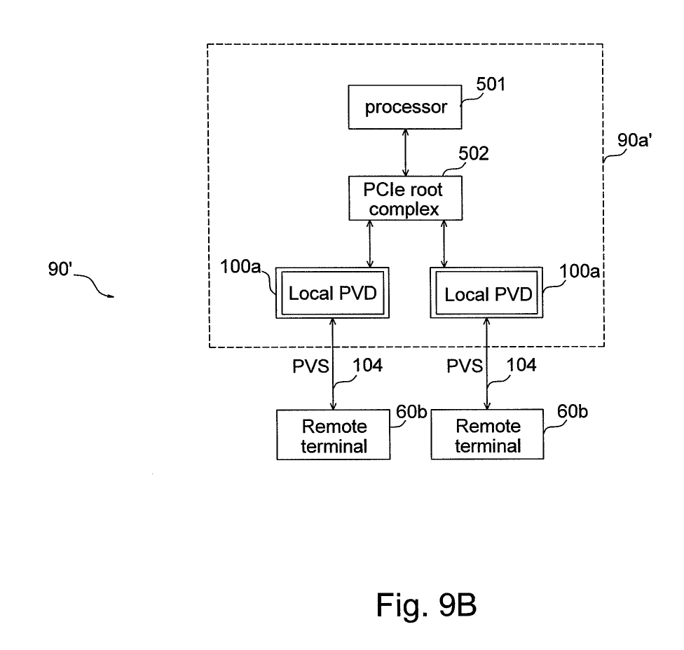

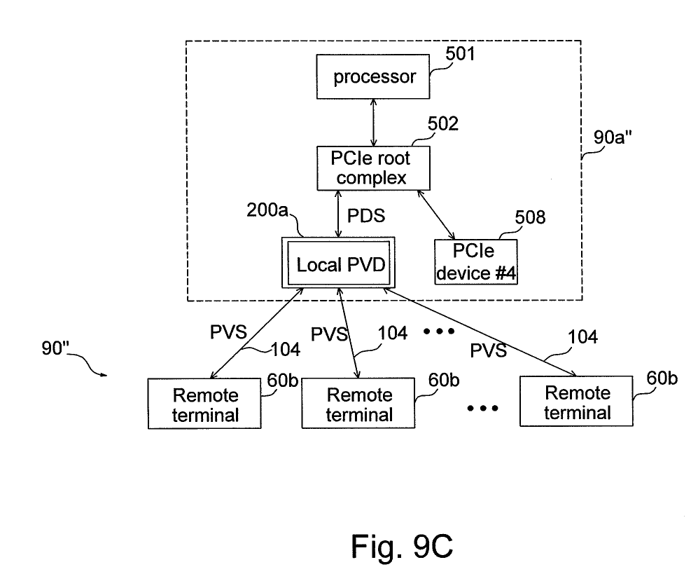

FIGS. 9A, 9B and 9C show other embodiments of the distant PCIe extended computer system 60. In FIG. 9A, a PVD couples to a switch but does not couple to a PCIe root complex. Further, the distant PCIe extended computer system 60 may have a PVD or a plurality of PVDs arranged for multiple paths controlling, such as system shown in FIGS. 9B and 9C. Also, the detailed operation principle of these embodiments can be understood through the above description for those who are skilled in the art and will not be repeated hereinafter.

The distant bus extended method according to the embodiments of the invention utilize the signal converting circuit to convert the PCIe physical signal into a data packet and then transmit the data packet through the transmission medium via the PVD PHY layer. By way of such approach, the distant bus extended method according to the embodiments of the invention can perform long distance data transmission due to the use of a twisted pair cable or an optical fiber line under consideration of lower cost. Furthermore, the physical layer circuit of the distant PCIe extended system according to the embodiments of the invention can be implemented by the existing devices provided with the physical layer circuit while the transmission medium of the distant PCIe extended system according to the embodiments of the invention can also utilize the existing twisted pair cable or optical line for data transmission. In conclusion, by way of the above mentioned approaches, the distant PCIe extended system according to the embodiments of the invention can greatly reduce the design expense and the production cost, therefore achieving the same or better transmission efficiency compared to the prior technique.

What is claimed is:

1. A distant PCIe extended computer system, comprising:
a host processor; and
a root complex, coupled between the host processor and a distant PCIe bus fabric, for initiating transaction requests on the behalf of the host processor, wherein the distant PCIe bus fabric comprising:
a transmission medium for transmission of a PVD physical signal;
at least a local PVD (PCIe Virtualization Device), coupled to the transmission medium, for converting signals between a PCIe physical signal and a PVD physical signal; and
at least a remote PVD, coupled to the transmission medium, for converting signals between the PCIe physical signal and the PVD physical signal;
wherein the host processor communicates with at least a PCIe device through the root complex and the distant PCIe bus fabric.

2. The system according to claim 1, wherein the local PVD receives the PCIe physical signal, processes the PCIe physical signal into at least a PCIe transaction layer packet and assembles a preamble and a PVD header or at least a code with the PCIe transaction layer packet to construct the PVD physical signal; and transmits the PVD physical signal over the transmission medium.

3. The system according to claim 1, wherein the remote PVD receives the PVD physical signal, and disassembles the PVD physical signal into the PCIe transaction layer packet and assembles a preamble and a PCIe header or at least a code with the PCIe transaction layer packet to construct the PCIe physical signal and forwards the PCIe physical signal to the PCIe bus in the distant PCIe bus fabric.

4. The system according to claim 1, wherein the transmission medium comprises one selected from the group consisting of the following: a twisted pair cable, CAT-5, CAT-5e, CAT-6, optical fiber line and the specification having speed preset by a designer.

5. The system according to claim 1, wherein the local PVD comprises:
a first PCIe PHY layer, for transforming the at least a PCIe physical signal into a PCIe data link layer packet;
a first PCIe data link layer, for determining if it is to receive the PCIe data link layer packet, wherein if the first PCIe data link layer determines to receive the PCIe data link layer packet, the first PCIe data link layer generates a PCIe transaction layer packet according to the PCIe data link layer packet;
a first PCIe transaction layer, for outputting the PCIe transaction layer packet;
at least a first PVD application layer, for assembling a PVD header (frame header) and a PVD CRC (optional) with the PCIe transaction layer packet to generate a PVD packet; and
at least a first PVD MAC layer, for assembling a preamble and a SFD with the PVD packet to generate the PVD MAC packet.
at least a first PVD PHY layer, for generating a PVD physical signal according to the PVD MAC packet.

6. The system according to claim 5, wherein the remote PVD comprises:
at least a second PVD PHY layer, for transforming the PVD physical signal into the PVD MAC packet;
at least a second PVD MAC layer, for checking errors of the received PVD MAC packet, and stripping the PVD header or the code to generate the PVD packet; and
at least a second PVD application layer, for identifying the PVD packet according to the PVD header and/or the PVD CRC, wherein if the data of the PVD header and/or the PVD CRC are valid, the second PVD application layer strips the PVD header and the PVD CRC to generate the PCIe transaction layer packet.
a second PCIe transaction layer, for outputting the PCIe transaction layer packet;
a second PCIe data link layer, for assembling the PCIe sequence number and the PCIe LCRC with the PCIe transaction layer packet to reconstruct the PCIe data link layer packet;
a second PCIe PHY layer, for restoring the PCIe data link layer packet into the PCIe physical signal.

7. The system according to claim 1, wherein the
local PVD comprises:
at least a first PVD application layer, for processing a sideband signal to be a PVD sideband data, and assembling a PVD header (frame header) and a PVD CRC (optional) with the PVD sideband data to generate a PVD packet; and
at least a first PVD MAC layer, for assembling a preamble and a code with the PVD packet to generate the PVD MAC packet;
at least a first PVD PHY layer, for generating a PVD physical signal according to the PVD MAC packet.

8. The system according to claim 7, wherein the remote PVD comprises:
at least a second PVD PHY layer, for transforming the PVD physical signal into the PVD MAC packet;
at least a second PVD MAC layer, for checking errors of the received PVD MAC packet, and stripping the PVD header or the code to generate the PVD packet; and
at least a second PVD application layer, for identifying the PVD packet according to the PVD header and/or the PVD CRC, wherein if the data of the PVD header and/or the PVD CRC are valid, the second PVD application layer strips the PVD header and the PVD CRC to generate the sideband signal.

9. The system according to claim 7, wherein the sideband signal signals are selected from the group consisting of the following: On/Off (OF), reset signal (Re), light emitting diode indicating signal (Led), wake up signal (WAKE) and general purpose I/O (GPIO).

10. The system according to claim 1, wherein the local PVD comprises:
at least a first PVD application layer, for processing a PVD link control data to be a PVD sideband data, and assembling a PVD header (frame header) and a PVD CRC (optional) with the PVD sideband data to generate a PVD packet; and
at least a first PVD MAC layer, for assembling a preamble and a code with the PVD packet to generate the PVD MAC packet.
at least a first PVD PHY layer, for generating a PVD physical signal according to the PVD MAC packet.

11. The system according to claim 10, wherein the remote PVD comprises:
at least a second PVD PHY layer, for transforming the PVD physical signal into the PVD MAC packet;
at least a second PVD MAC layer, for checking errors of the received PVD MAC packet, and stripping the PVD header or the code to generate the PVD packet; and
a second PVD application layer, for identifying the PVD packet according to the PVD header and/or the PVD CRC, wherein if the data of the PVD header and/or the PVD CRC are valid, the second PVD application layer strips the PVD header and the PVD CRC to generate the PVD link control data.

12. A PVD (PCIe virtualization device), comprising:
a PCIe PHY layer, for decoding a first PCIe physical signal and strips the PCIe start and the PCIe end to generate a first PCIe data link layer packet; or for receiving a second PCIe data link layer packet, concatenating a PCIe start and a PCIe end to the second PCIe data link layer packet, and reconstructing a second PCIe physical signal; and
a PCIe data link layer, coupled to the PCIe PHY layer, for receiving the first PCIe data link layer packet, determining whether stripping the PCIe sequence number and the PCIe LCRC from the first PCIe data link layer packet or not to let a first PCIe transaction layer packet remain; or for assembling a PCIe sequence number and a PCIe LCRC with a second PCIe transaction layer packet to reconstruct the second PCIe data link layer packet;
a PCIe transaction layer, coupled to the PCIe data link layer, for receiving and forwarding the first PCIe transaction layer packet or the second PCIe transaction layer packet;
at least a PVD application layer, coupled to the PCIe transaction layer, for assembling a PVD header and a PVD CRC (optional) with the first PCIe transaction layer packet to generate a first PVD packet; for identifying a second PVD packet according to the PVD header and the PVD CRC and determining whether stripping the PVD header and the PVD CRC or not to generate the second PCIe transaction layer packet;
at least a PVD MAC layer, coupled to the PVD application layer, for assembling a preamble and a SFD with the first PVD packet to generate a first PVD MAC layer packet, or checking errors of a second PVD MAC packet, and stripping the preamble and the SFD to generate the second PVD packet; and
at least a PVD PHY layer, coupled to the PVD MAC layer, for transmitting or receiving the first PVD physical signal or the second PVD physical signal through at least a transmission medium.

13. The PVD according to claim 12, wherein the transmission medium is a wisted pair cable or an optical fiber line.

14. The PVD according to claim 12, wherein the PCIe PHY layer coupled to a PCIe requester and the PCIe requester is used for receiving the first PCIe physical signal including a PCIe start, a PCIe sequence number, a PCIe header, a PCIe data, a PCIe ECRE, a PCIe LCRC and a PCIe end, and the PCIe requester can be a processor, a PCIe root complex, a PCIe switch or a PCIe device.

15. The PVD according to claim 12, wherein the PCIe PHY layer coupled to at least a PCIe completer and the PCIe completer is used for receiving the second PCIe physical signal and controlling peripheral devices according to the second PCIe physical signal, and the PCIe completer can be a PCIe device.

16. The PVD according to claim 12, wherein the first or second PCIe transaction layer packet includes the PCIe header, PCIe data and PCIe ECRE, and the PCIe ECRE is optional and can be omitted from the first or second PCIe transaction layer packet; if the ECRC exists in the first or second PCIe transaction layer packet, the PCIe transaction layer checks for ECRC errors and strips the ECRC to reduce the total packet size of the first or second PCIe transaction layer packet; or the first or second PCIe transaction layer packet is only contain the PCIe header and does not contain the PCIe data.

17. The PVD according to claim 12, wherein the first or second PCIe transaction later packet in the PVD packet is substituted for a sideband signal or a PVD Link control data.

18. A distant PCIe extended system, comprising:
a local PVD (PCIe Virtualization Device), for transforming a first PCIe physical signal into a plurality of first PVD physical signals; or for transforming a plurality of second PVD physical signals into a second PCIe physical signal, comprising:
a PCIe PHY layer, for decoding the first PCIe physical signal to generate a first PCIe data link layer packet; or for receiving a second PCIe data link layer packet and reconstructing the second PCIe physical signal; and
a signal converting circuit, coupled to the PCIe PHY layer, for transforming the first PCIe data link layer packet into a plurality of first PVD MAC packets; or for transforming a plurality of second PVD MAC packets into the second PCIe data link layer packet;
a plurality of PVD PHY layers, coupled to the signal converting circuit, wherein each of the PVD PHY layer is used for transforming a correspondent first PVD MAC packet into the first PVD physical signal; or for transforming the correspondent second PVD physical signal into the second PVD MAC packet; and
a plurality of transmission mediums, coupled to the plurality of PVD PHY layers, wherein each of the transmission medium is used for transferring the correspondent first PVD physical signal or the correspondent second PVD physical signal;
and
a plurality of remote PVDs, coupled to the plurality of transmission mediums, wherein each of the remote PVD is used for transforming the first PVD physical signal into the first PCIe physical signal; or for transforming the second PCIe physical signal into the second PVD physical signal.

19. The system according to claim 18, wherein the signal converting circuit comprising:
a PCIe data link layer, coupled to the PCIe PHY layer, for receiving the first PCIe data link layer packet, determining whether stripping the PCIe sequence number and the PCIe LCRC from the first PCIe data link layer packet or not to let a first PCIe transaction layer packet remain; or for assembling a PCIe sequence number and a PCIe LCRC with a second PCIe transaction layer packet to reconstruct the second PCIe data link layer packet;
a PCIe transaction layer, coupled to the PCIe data link layer, for receiving and forwarding the first PCIe transaction layer packet or the second PCIe transaction layer packet;
a plurality of PVD application layers, coupled to the PCIe transaction layer, wherein each of the PVD application layer is used for assembling a PVD header and a PVD CRC (optional) with the first PCIe transaction layer packet to generate a first PVD packet; for identifying a second PVD packet according to the PVD header and the PVD CRC and determining whether stripping the PVD header and the PVD CRC or not to generate the second PCIe transaction layer packet; and
a plurality of PVD MAC layers, coupled to the PVD application layer, wherein each of the PVD MAC layer is used for assembling a preamble and a SFD with the first PVD packet to generate a first PVD MAC layer packet, or checking errors of a second PVD MAC packet, and stripping the preamble and the SFD to generate the second PVD packet.

20. The system according to claim 19, wherein the first or second PCIe transaction later packet in the PVD packet is substituted for a sideband signal or a PVD Link control data.
